(19) United States
(12) Patent Application Publication
(10) Pub. No.: US 2010/0225613 A1
(43) Pub. Date: Sep. 9, 2010

(54) TOUCH PANEL

(75) Inventor: Makoto IWASAKI, Akishima-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 12/716,629

(22) Filed: Mar. 3, 2010

(30) Foreign Application Priority Data
Mar. 4, 2009 (JP) 2009-051026

(51) Int. Cl. G06F 3/041; G06F 3/045

(52) U.S. Cl. 345/174

(57) ABSTRACT

A touch panel includes a first substrate, a second substrate disposed to face the first substrate, and an insulating liquid confined in a gap between the first substrate and the second substrate. The first substrate is provided with linear contacts in a region where the insulating liquid is confined. The linear contacts project at a predetermined height and extend in a predetermined direction. The second substrate is provided with a resistive film, which is formed to correspond to at least the location of the linear contacts.

### CROSS-REFERENCE TO RELATED APPLICATIONS

This application is based upon and claims the benefit of priority from prior Japanese Patent Application No. 2009-051026, filed Mar. 4, 2009, the entire contents of which are incorporated herein by reference.

### BACKGROUND OF THE INVENTION

1. Field of the Invention

This invention relates to a resistive film type touch panel.

2. Description of the Related Art

In a resistive film type touch panel, a first substrate on which a first resistive film is formed and a second substrate on which a second resistive film is formed are arranged so that the first resistive film and the second resistive film face each other. This resistive film type touch panel is configured so that one of the substrates touched by a user is bent and deformed by pressing at the touched position and then the first resistive film and the second resistive film come into contact with each other in a region corresponding to the touched position. Then, the position where the first resistive film and the second resistive film are in contact with each other is detected as a position touched by the user.

In such a resistive film type touch panel, a plurality of spacers are provided between the first substrate and the second substrate to provide a gap between the first substrate and the second substrate so that the first resistive film and the second resistive film may not come into contact with each other when there is no input touch (Jpn. Pat. Appln. KOKAI Publication No. 61-45519).

However, when a great gap is set between the first substrate and the second substrate so as to prevent unnecessary contact between the first substrate and the second substrate, the substrate has to be touched so that the substrate may be bent and deformed to a great extent in order to bring the first resistive film and the second resistive film into contact with each other.

Therefore, in a touch-panel-equipped display apparatus in which the above-described conventional resistive film type touch panel is disposed on an image display surface of a display panel such as a liquid crystal display panel, light exiting from the display panel is greatly refracted in the part where the resistive film type touch panel is bent and deformed, and an image in this part appears to be distorted.

### BRIEF SUMMARY OF THE INVENTION

An object of the present invention is to provide a resistive film type touch panel in which, when it is touched by a user, the change of the path of light transmitted through the part bent and deformed by touching can be reduced.

A touch panel according to an aspect of the present invention includes a first substrate; a second substrate disposed to face the first substrate; an insulating liquid confined in a gap between the first substrate and the second substrate; linear contacts formed on the first substrate in a region where the insulating liquid is confined, the linear contacts projecting at a predetermined height and extending in a predetermined direction; and a resistive film formed on the second substrate so as to correspond to at least the location of the linear contacts.

A touch panel according to another aspect of the present invention includes a first substrate; a second substrate disposed to face the first substrate; an insulating liquid confined in a gap between the first substrate and the second substrate; linear contacts formed on the first substrate in a region where the insulating liquid is confined, the linear contacts projecting at a predetermined height and extending in a predetermined direction; and linear contact receivers formed on the second substrate, the linear contact receivers projecting at a predetermined height and extending in a direction intersecting with the extending direction of the linear contacts.

According to the present invention, when a touch panel is touched by a user, the change of the path of light transmitted through the part bent and deformed by touching can be reduced.

Advantages of the invention will be set forth in the description which follows, and in part will be obvious from the description, or may be learned by practice of the invention. The Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a side view of a touch-panel-equipped display apparatus;

FIG. 2 is a plan view of a touch panel in a first embodiment;

FIG. 3 is a plan view of the configuration of the touch panel in the first embodiment on the side of a third transparent substrate;

FIG. 4 is a plan view of the configuration of the touch panel in the first embodiment on the side of a fourth transparent substrate;

FIG. 5 is a diagram showing the positional relation between a plurality of linear contacts and a plurality of spacers in the touch panel in the first embodiment;

FIG. 6 is a sectional view of the touch panel in the first embodiment;

FIG. 7 is an enlarged sectional view taken along the line VII-VII in FIG. 6;

FIG. 8 is a sectional view taken along the line VIII-VIII in FIG. 7;

FIG. 9 is a sectional view of a part corresponding to FIG. 6 during touch-input;

FIG. 10 is a sectional view of a part corresponding to FIG. 7 during touch-input;

FIG. 11 is a diagram showing a touch panel drive circuit;

FIG. 12 is a sectional view of part of a touch panel in a second embodiment;

FIG. 13 is a sectional view of part of a touch panel in a third embodiment;

FIG. 14 is a sectional view of part of a touch panel in a fourth embodiment;

FIG. 15 is a plan view of the configuration of a touch panel in a fifth embodiment on the side of a fourth transparent substrate;

FIG. 16 is a diagram showing the positional relation between a plurality of linear contacts, a plurality of linear contact receivers and a plurality of spacers in the touch panel in the fifth embodiment;

FIG. 17 is an enlarged sectional view of part of the touch panel in the fifth embodiment; and

FIG. 18 is a sectional view taken along the line XVIII-XVIII in FIG. 17.

### DETAILED DESCRIPTION OF THE INVENTION

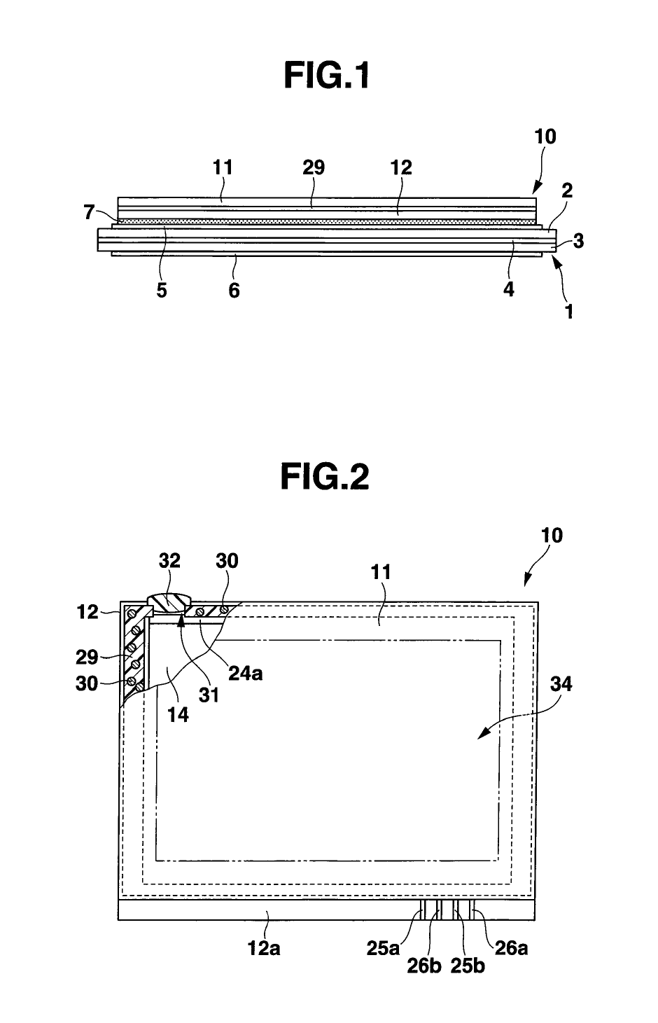

A touch-panel-equipped display apparatus is shown in FIG. 1. This display apparatus comprises a display panel 1 for displaying images, and a resistive film type touch panel 10 disposed on the image display surface of the display panel 1.

The display panel 1 is, for example, a liquid crystal display panel which controls, per display pixel, the transmission amount of light radiated from a backlight to display images. In the liquid crystal display panel, a first transparent substrate 2 and a second transparent substrate 3 are arranged to face each other with a predetermined gap. The first transparent substrate 2 and the second transparent substrate 3 are joined together through a frame-like seal member 4 at the peripheral edge. Further, liquid crystal is confined in a region enclosed by the seal member 4 so that a liquid crystal layer is formed in the gap between the first transparent substrate 2 and the second transparent substrate 3. A space defined by the seal member 4 and the first and second transparent substrates 2 and 3 is filled with the liquid crystal. In addition, a transparent electrode for applying a voltage to the liquid crystal per display pixel is formed in the first transparent substrate 2 or the second transparent substrate 3. Moreover, the liquid crystal display panel includes a first polarizing plate 5 and a second polarizing plate 6 which are arranged to hold the first transparent substrate 2 and the second transparent substrate 3 in between.

It is to be noted that the liquid crystal layer in the liquid crystal display panel may have nematic liquid crystal in TN alignment, STN alignment, nontwist homogeneous alignment, vertical alignment or bend alignment, or may have ferroelectric or antiferroelectric liquid crystal.

Furthermore, the transmission amount of light in the liquid crystal display panel may be controlled in the following manner: Electrodes are formed to generate a vertical electric field in the liquid crystal layer, and the alignment direction of liquid crystal molecules is changed by the vertical electric field to control the transmission amount of light. Alternatively, electrodes are formed to generate a horizontal electric field in the liquid crystal layer, and the alignment direction of the liquid crystal molecules is changed by the horizontal electric field to control the transmission amount of light.

Moreover, the display panel 1 is not exclusively a liquid crystal display panel, and may be a light-emitting-type display panel such as an organic electroluminescent (EL) display panel.

The touch panel 10 is disposed to face the liquid crystal display panel 1. In this case, the touch panel 10 is affixed to the first polarizing plate 5 of the liquid crystal display panel 1 by an adhesive layer 7 made of a transparent pressure sensitive adhesive material or resin.

### Embodiment 1

A touch panel 10 in a first embodiment of this invention is disposed so that a third transparent substrate 11 and a fourth transparent substrate 12 face each other, as shown in FIG. 2 to FIG. 10. Then, the fourth transparent substrate 12 is affixed to a liquid crystal display panel 1 so that, for example, the third transparent substrate 11 may be touched by a user.

The third transparent substrate 11 is provided with a plurality of linear projections 16 and a single first resistive film 13 on the surface facing the fourth transparent substrate 12. Each of the linear projections 16 is linearly disposed to extend in a predetermined direction, and projects toward the fourth transparent substrate 12. The first resistive film 13 is formed to maintain steps produced by the linear projections 16 on the surface of the first resistive film 13 and to cover the linear projections 16.

Furthermore, the fourth transparent substrate 12 is provided with a single second resistive film 14 and a plurality of spacers 17 on the surface facing the third transparent substrate 11. The second resistive film 14 is formed so that its surface may be planar. Each of the spacers 17 is formed on the second resistive film 14 so as to avoid the position overlapping the linear projection 16 and so as to project toward the third transparent substrate 11. The spacers 17 are formed as dot-shaped projections.

Here, the spacers 17 are to maintain a constant gap between the third transparent substrate 11 and the fourth transparent substrate when the third transparent substrate is not touched by the user. The spacers 17 are formed by an insulating transparent material to have such a height that the tips of these spacers 17 are in contact with the surface (the first resistive film 13) of the third transparent substrate 11 even when the third transparent substrate is not touched by the user.

Furthermore, the linear projections 16 and regions of the first resistive film 13 overlapping the linear projections 16 constitute linear contacts 15. The linear contacts 15 are formed to contact the second resistive film 14 owing to bending and deformation of the third transparent substrate 11 when the third transparent substrate is touched by the user. Thus, the linear projections 16 are formed to be lower than the spacers 17 so that the linear contacts 15 are out of contact with the second resistive film 14 when the third transparent substrate is not touched by the user.

The third transparent substrate 11 is made of a resin film or a glass plate 0.2 to 0.3 mm thick having a rectangular planar shape. Moreover, the fourth transparent substrate 12 is in a rectangular form greater in area than the third transparent substrate 11. The fourth transparent substrate 12 is disposed so that part of its region extends beyond one side of the third transparent substrate 11 as an extension 12a. The fourth transparent substrate 12 can be thicker than the third transparent substrate 11, and is made of, for example, a glass plate 0.5 to 1.1 mm thick.

In addition, when a soda glass plate or the like is used for the fourth transparent substrate 12, it is desirable to form a transparent SiO₂ (silicon dioxide) film over the entire surface of the fourth transparent substrate 12 facing the third transparent substrate 11 and provide the second resistive film 14 thereon, in order to ensure the performance of the adhesion of the second resistive film 14 to the fourth transparent substrate 12 and prevent pollution within the touch panel. When a soda glass plate or the like is used for the third transparent substrate 11, it is desirable to form a transparent SiO₂ film over the entire surface of the third transparent substrate 11 facing the fourth transparent substrate 12 and provide the first resistive film 13 thereon.

In this touch panel 10, out of the region where the third transparent substrate 11 and the fourth transparent substrate 12 overlap each other, a rectangular region except for its peripheral edge serves as a touch area 34 for touch-input.

The third transparent substrate 11 and the fourth transparent substrate 12 are joined together by a frame-like seal member 29 which is disposed at the peripheral edge between the third transparent substrate 11 and the fourth transparent substrate 12 in such a manner as to enclose the touch area 34. Although described later in detail, an insulating material which is in a liquid state at room temperature (25° C.) is confined in a region enclosed by the frame-like seal member 29.

Each of the first and second resistive films 13 and 14 is in a rectangular shape greater than the touch area 34. The linear contact 15 is formed, for example, along the long-side direction of the touch area 34 in a region corresponding to the touch area 34 to have a length substantially equal to the width of the touch area 34 in its long-side direction. In addition, a plurality of linear contacts 15 are arranged so that adjacent linear contacts 15 are parallel to each other. That is, a plurality of linear projections 16 are arranged parallel to each other in the long-side direction of the touch area 34. In addition, the linear projections 16 are desirably formed of a transparent material.

The linear projections 16 can be formed by patterning a photosensitive resin. Specifically, the third transparent substrate 11 is spin-coated with the photosensitive resin with a predetermined thickness. Then, the coating photosensitive resin is exposed using an exposure mask in which light-shielding regions are arranged in patterns corresponding to the linear projections 16. Further, the exposed photosensitive resin is developed, such that the linear projections 16 uniform in height can be easily obtained.

In addition, the photosensitive resin is sequentially developed starting from the front side of the film in a development process after the exposure process, and parts closer to the front side of the film are therefore exposed to a developer for a longer time at the edge of the pattern. Thus, each of the linear projections 16 is formed so that the sectional shape of the linear projection 16 perpendicular to its extending direction (sectional shape in the width direction) decreases in width from the base to the top. In this embodiment, for example, the width of the base is 15 to 30 μm, the height is 5 to 8 μm, and the section is in a trapezoidal shape having an inclination angle of 40° to 50°.

Each of the first and second resistive films 13 and 14 is made of a transparent conductive coating such as an ITO film which is formed into a thickness of 0.05 to 0.20 μm by a plasma CVD device. Here, as described above, the linear contact 15 is composed of the linear projection 16 and a region of the first resistive film 13 overlapping the linear projection 16. Then, as described above, the linear projection 16 is formed so that its inclination angle may be 40° to 50°, whereby the first resistive film 13 covers the linear projection 16 in a satisfactory manner, and at the same time, the properly projecting shape of the linear contact 15 can be maintained. That is, when the inclination angle of the linear projection 16 is 40° to 50°, the first resistive film 13 can be formed into a single film having a uniform thickness over the linear projection 16, and at the same time, the linear contact 15 can be formed into the properly projecting shape.

The spacers 17 are formed on the second resistive film 14 in a region corresponding to the touch area 34. Here, the spacers 17 are formed by a transparent insulating material into columnar shapes greater a predetermined height than the linear contacts 15 in such a manner as to avoid the regions to overlap the linear contacts 15 or the linear projections 16. That is, the spacer 17 is formed as a columnar spacer having a circular planar shape.

The spacers 17 can be formed by patterning a photosensitive resin, similarly to the linear projections 16. Specifically, the fourth transparent substrate 12 on which the second resistive film 14 is formed is spin-coated with a transparent acrylic photosensitive resin with a predetermined thickness. The coating thickness of the photosensitive resin in this case is set to be greater than the coating thickness of the photosensitive resin for forming the linear projections 16. Then, the coating photosensitive resin is exposed using an exposure mask in which light-shielding regions are arranged in patterns corresponding to the spacers 17. Further, the exposed photosensitive resin is developed, such that the spacers 17 uniform in height can be easily obtained.

In addition, the photosensitive resin for forming the spacers 17 is also sequentially developed starting from the front side of the film in the development after the exposure, and parts closer to the front side of the film are therefore exposed to a developer for a longer time at the edge of the pattern. Thus, each of the spacers 17 is formed so that the sectional shape decreases in width from the base to the top. In this embodiment, for example, the diameter of the base is 15 to 30 μm, the height is 7 to 10 μm, and the section is in a trapezoidal shape having an inclination angle of 40° to 50°.

The linear contacts 15 and the spacers 17 are arranged at predetermined intervals in the region corresponding to the touch area 34, that is, in the region enclosed by the seal member 29. Moreover, one or more linear contacts 15 are disposed between two spacers 17, 17 adjacent in a direction perpendicular to the extending direction of the linear contacts 15.

In this embodiment, one columnar spacer 17 is disposed at each of four corners of a predetermined square region. The linear contacts 15 are arranged at predetermined intervals in at least the square region.

In addition, the linear contacts 15 are arranged in patterns in which non-contact regions are preserved by omitting one linear contact 15 every predetermined number of linear contacts 15. The spacers 17 are arranged with substantially the same pitch as the pitch of the non-contact regions parallel to the length direction of the linear contacts 15 in such a manner as to correspond to the non-contact regions where the linear contacts 15 are omitted.

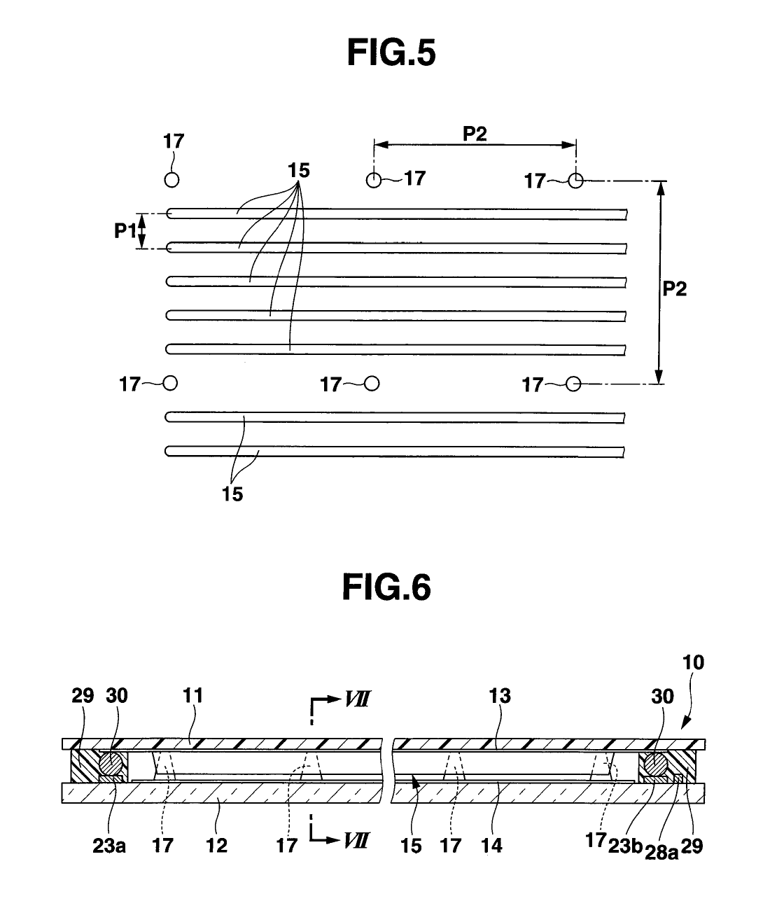

For example, as shown in FIG. 5, the linear contacts 15 are arranged with a pitch P1 of 0.05 mm, 0.1 mm or 0.2 mm perpendicularly to the extending direction of the linear contacts 15. The spacers 17 provided in such a manner as to correspond to the non-contact regions where the linear contacts 15 are omitted are arranged with a pitch P2 of 2 mm or 4 mm in directions parallel and perpendicular to the extending direction of the linear contacts 15.

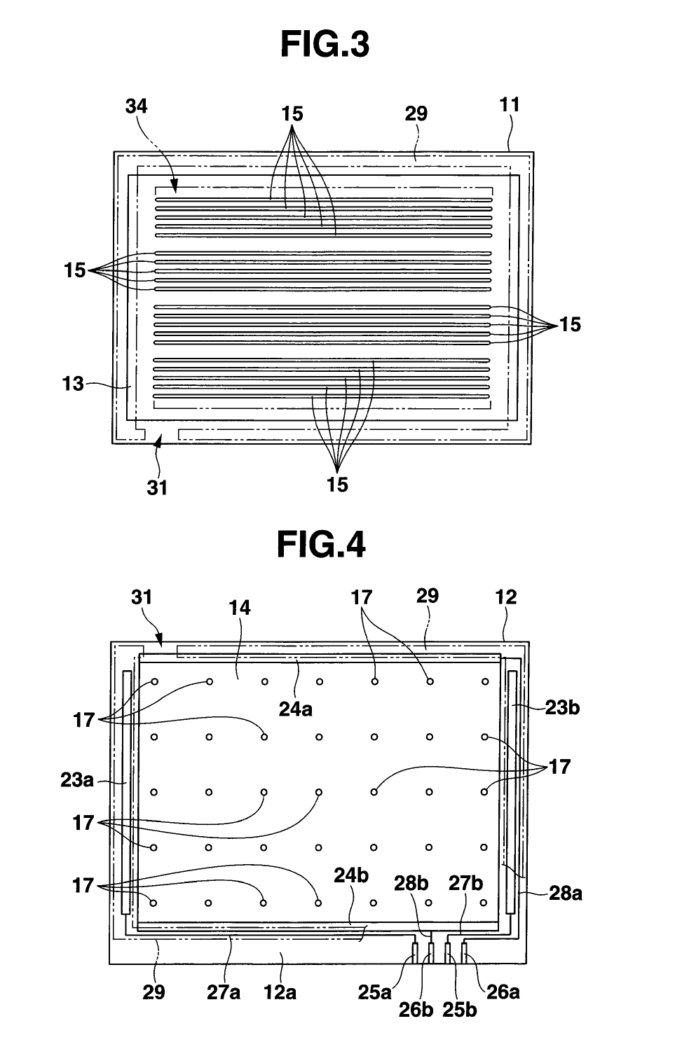

In addition, in FIG. 3 and FIG. 5 to FIG. 10, for the sake of convenience, a non-contact region for one line is provided every five linear contacts 15, and the spacers 17 are arranged in line in this region. On the other hand, when the pitch P1 of the linear contacts 15 is 0.05 mm and the pitch P2 of the spacers 17 is 2 mm, a non-contact region for one line is provided every 38 linear contacts 15, and the spacers 17 are arranged in line in this region. When P1 is 0.2 mm and P2 is 4 mm, a non-contact region for one line is provided every 18 linear contacts 15, and the spacers 17 are arranged in line in this region.

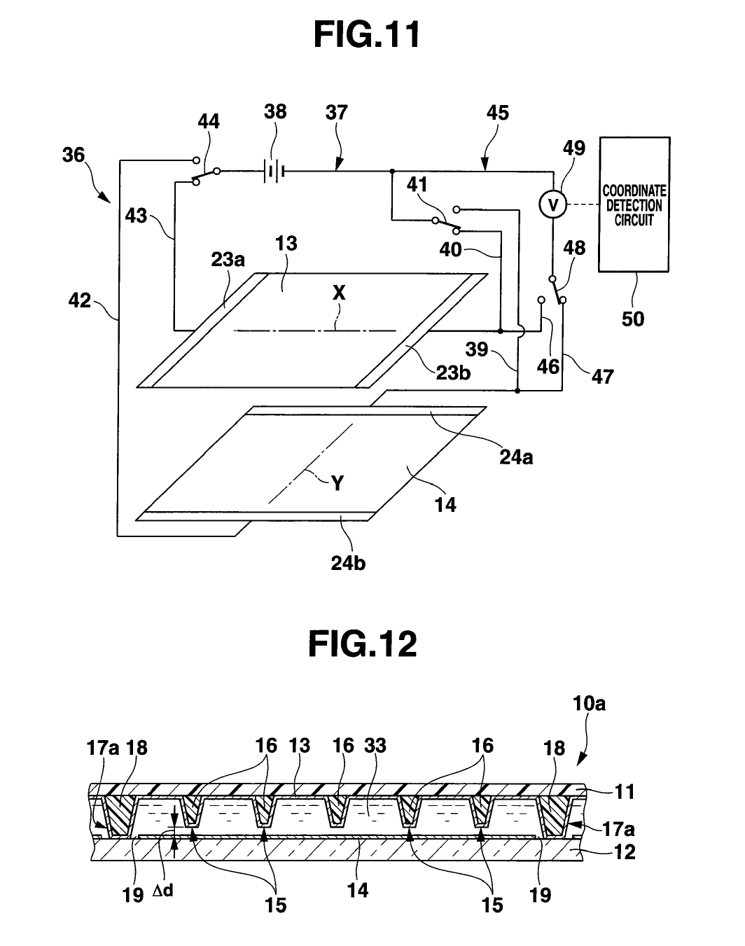

In the extension 12a of the fourth transparent substrate 12, a plurality of, for example, four drive circuit connecting terminals 25a, 25b, 26a, 26b are provided to connect, to a touch panel drive circuit 36 shown in FIG. 11, both ends of one direction of the first resistive film 13 provided on the third transparent substrate 11, for example, the long-side direction of the touch area 34 (hereinafter referred to as an X-axis direction) and both ends of the direction of the second resistive film 14 provided on the fourth transparent substrate 12 perpendicular to the above-mentioned one direction, that is, the short side direction of the touch area 34 (hereinafter referred to as a Y-axis direction).

Furthermore, on the same surface as the surface where the drive circuit connecting terminals 25a, 25b, 26a, 26b are provided, there are provided a plurality of first electrodes 23a, 23b formed at positions corresponding to both edges of the first resistive film 13 in the X-axis direction, a plurality of second electrodes 24a, 24b formed at positions corresponding to both edges of the second resistive film 14 in the Y-axis direction, and a plurality of wiring lines 27a, 27b, 28a, 28b for electrically connecting the first electrodes 23a, 23b or the second electrodes 24a, 24b to the four drive circuit connecting terminals 25a, 25b, 26a, 26b provided in the extension 12a.

The first resistive film 13 provided on the third transparent substrate 11 is formed into such a shape that its side portions at both ends of the X-axis direction are located in a seal portion formed by the frame-like seal member 29 and that its side portions at both ends of the Y-axis direction perpendicular to the X-axis direction are located inside the seal portion. The second resistive film 14 provided on the fourth transparent substrate 12 is formed into a such shape that its side portions at both ends of the X-axis direction are located inside the seal portion and that its side portions at both ends of the Y-axis direction correspond to the vicinity of the seal portion or correspond to the seal portion.

The first electrodes 23a, 23b respectively facing the side portions at both ends of the first resistive film 13 in the X-axis direction are provided in the seal portion. The second electrodes 24a, 24b respectively formed in the side portions at both ends of the second resistive film 14 in the Y-axis direction are stacked on the second resistive film 14.

In addition, in the touch panel 10, the first electrodes 23a, 23b are respectively provided to face each other in the side portions at one end of the first resistive film 13 and the other in the X-axis direction, and the second electrodes 24a, 24b are respectively provided to face each other in the side portions at one end of the second resistive film 14 and the other in the Y-axis direction. The two first electrodes 23a, 23b are respectively formed into a continuous belt shape to face each other over the substantially entire lengths of the side portions at both ends of the first resistive film 13 in the X-axis direction. The two second electrodes 24a, 24b are respectively formed into a continuous belt shape over the substantially entire lengths of the side portions at both ends of the second resistive film 14 in the Y-axis direction.

The two first electrodes 23a, 23b and the two second electrodes 24a, 24b are respectively connected to the four drive circuit connecting terminals 25a, 25b, 26a, 26b provided in the extension 12a by the plurality of (four in this embodiment) wiring lines 27a, 27b, 28a, 28b provided in the parts corresponding to the seal portion.

In addition, the first electrodes 23a, 23b and the second electrodes 24a, 24b, the drive circuit connecting terminals 25a, 25b, 26a, 26b and the wiring lines 27a, 27b, 28a, 28b are produced by forming, on the opposite substrate 12 or the second resistive film 14 in a stacked manner, a first layer made of molybdenum, a second layer made of an aluminum based alloy and a third layer made of molybdenum and then patterning the three-layer stack film.

The third transparent substrate 11 and the fourth transparent substrate 12 are arranged and joined together by the frame-like seal member 29 so that the first resistive film 13 and the second resistive film 14 face each other and so that the tips of the spacers 17 provided on the fourth transparent substrate 12 are in contact with the first resistive film 13. Here, a gap corresponding to the difference between the height of the linear projections 16 and the height of the columnar spacers 17 is formed between the tops (tips) of the linear contacts 15 and the second resistive film 14. For example, when the height of the linear projections 16 is 8 μm and the height of the columnar spacers 17 is 10 μm, the gap between the linear contacts 15 and the second resistive film 14 is set at 2 μm.

Furthermore, the side portions at both ends of the first resistive film 13 in the X-axis direction are electrically connected to the two first electrodes 23a, 23b by a conductive member in the seal portion formed by the seal member 29.

The seal portion is composed of the frame-like seal member 29 and a plurality of spherical conductive particles 30. The conductive particles 30 are dispersed in the seal member 29 as conductive members for electrically connecting the side portions at both ends of the first resistive film 13 in the X-axis direction to the two first electrodes 23a, 23b. The conductive particles 30 have a diameter corresponding to the gap between a pair of substrates 11, 12.

The seal member 29 is printed on either the third transparent substrate 11 or the fourth transparent substrate 12 into a shape in which the side portion corresponding to the edge of the side opposite to the side where the extension 12a is formed is partly eliminated to form a liquid filling hole 31. Then, the third transparent substrate 11 and the fourth transparent substrate are joined together so that each of the spacers 17 is in contact with the first resistive film 13. In this condition, the seal member 29 is cured so that the substrates are joined together through the seal member 29. At the same time, the gap between the third transparent substrate 11 and the fourth transparent substrate is regulated by the spacers 17.

When the third transparent substrate 11 and the fourth transparent substrate 12 are joined together through the seal member 29, the side portions at both ends of the first resistive film 13 provided on the third transparent substrate 11 in the X-axis direction are electrically connected to the two first electrodes 23a, 23b provided on the fourth transparent substrate 12 by the conductive particles 30 located between the first resistive film 13 and the first electrodes 23a, 23b among the spherical conductive particles 30 dispersed in the seal member 29.

Furthermore, the region enclosed by the seal member 29 between the third transparent substrate 11 and the fourth transparent substrate 12 is filled with an insulating liquid 33 by a vacuum injection method. Specifically, the third transparent substrate 11 and the fourth transparent substrate 12 that are joined by the seal member 29 are disposed in a sealed chamber. Then, a vacuum is formed in the chamber, and the liquid filling hole 31 is thus immersed in a bath filled with the insulating liquid 33. In this condition, the pressure in the chamber is brought back to atmospheric pressure. As a result, the gap between the third transparent substrate 11 and the fourth transparent substrate 12 is filled with the insulating liquid 33 through the liquid filling hole 31 due to the pressure difference between the inside and outside the chamber and due to a capillary phenomenon. The liquid filling hole 31 is sealed with a sealing resin 32 after the filling with the insulating liquid 33. Thus, the insulating liquid 33 filling the gap between the third transparent substrate 11 and the fourth transparent substrate 12 is in a confined state.

The insulating liquid 33 is a transparent liquid of which refractive index is set so that both the difference between the refractive index of the insulating liquid 33 and the refractive index of light in the third transparent substrate 11 and the difference between the refractive index of the insulating liquid 33 and the refractive index of light in the fourth transparent substrate 12 are 0.1 or less. For example, when both the third transparent substrate 11 and the fourth transparent substrate 12 are glass plates having a refractive index of 1.5, the refractive index of the insulating liquid 33 is set in a range from about 1.4 to 1.6. In addition, the refractive index of the insulating liquid 33 is preferably set at a value closer to the refractive index of the third transparent substrate 11 or the refractive index of the fourth transparent substrate 12.

Furthermore, the insulating liquid 33 may be made of any material as long as such a material is optically isotropic at room temperature, and may be, for example, liquid crystal which shows an isotropic phase at a temperature of 5° C. or more (nematic liquid crystal having an N-I point less than 5° C.). Specifically, a known material having such characteristics has two or three cyclohexane or benzene rings, and an alkyl group at both ends thereof.

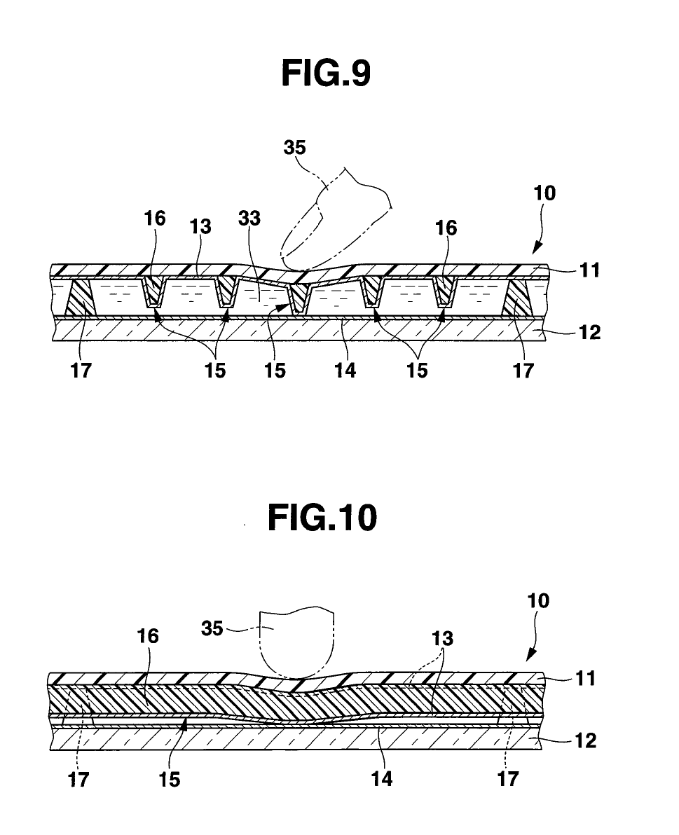

When the touch panel 10 is touched for input by the user, the surface of the touch panel 10 is touched from the side of the third transparent substrate 11 as shown in FIG. 9 and FIG. 10. If the third transparent substrate 11 is touched and pressing force is thereby applied to the third transparent substrate 11, the third transparent substrate 11 bends and deforms toward the fourth transparent substrate 12 in regions where no spacers 17 are arranged out of the touched part of the third transparent substrate 11. Then, the top of the linear contact 15 located in the bent and deformed region locally contacts the second resistive film 14. At this contact position, the first resistive film 13 and the second resistive film 14 are brought into conduction.

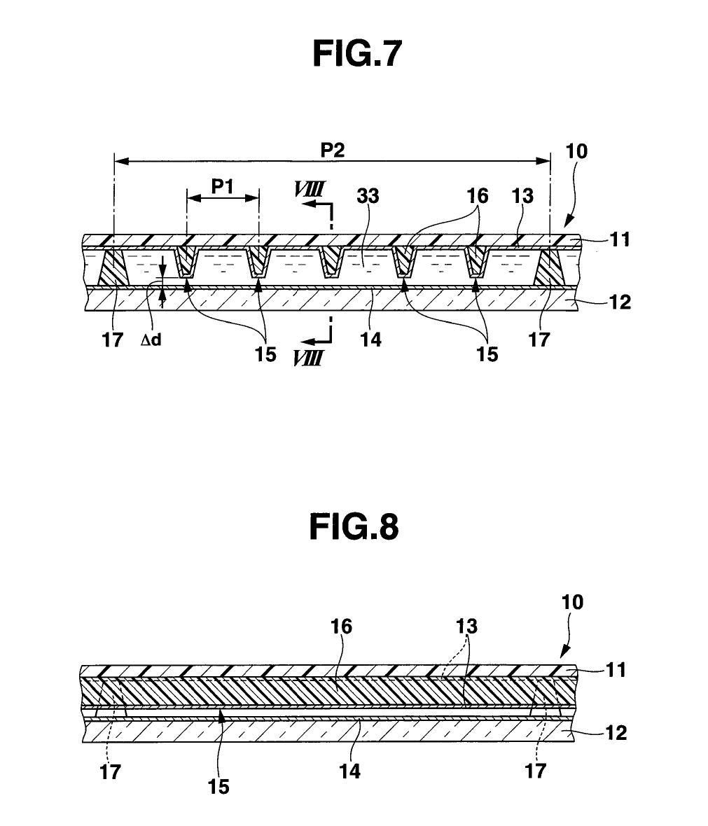

In this touch panel 10, a gap Δd (see FIG. 7) between the linear contacts 15 and the second resistive film 14 corresponds to the difference between the height of the linear projections 16 and the height of the columnar spacers 17 because the second resistive film 14 is formed with a uniform thickness.

Therefore, according to this touch panel 10, a slightly great gap is formed between the third transparent substrate 11 and the fourth transparent substrate 12 so that the gap is easily filled with the insulating liquid 33, and at the same time, the bending and deforming amount of the third transparent substrate 11 necessary to bring the first resistive film 13 and the second resistive film 14 into conduction by touching can be smaller than the bending and deforming amount corresponding to the above gap.

For example, when the height of the linear projections 16 is 3.5 μm and the height of the spacers 17 is 4.0 μm, a gap of at least 4.0 μm is secured between the third transparent substrate 11 and the fourth transparent substrate 12, and at the same time, the gap Δd between the linear contacts 15 and the second resistive film 14 can be set at 0.5 μm which is sufficiently smaller than 4.0 μm. Thus, in such a case, if the third transparent substrate 11 is bent and deformed to reduce the gap between the third transparent substrate 11 and the fourth transparent substrate 12 by 0.5 μm, the first resistive film 13 and the second resistive film 14 can be brought into sufficient conduction.

Consequently, according to the touch panel 10, the change of the path of light transmitted through the part bent and deformed by touching can be reduced. Therefore, in the touch-panel-equipped display apparatus shown in FIG. 1, the user can observe an image displayed on the display panel 1 through the touch panel 10 perceiving little distortion in the image when touching the touch panel 10.

Moreover, according to the touch panel 10, the bending and deforming amount of the third transparent substrate 11 necessary to bring the first resistive film 13 and the second resistive film 14 into conduction is small, so that touch-input can be performed with slight pressing force, and a sense of light touch can be obtained.

Furthermore, in the touch panel 10, the insulating liquid 33 is confined in the gap between the third transparent substrate 11 and the fourth transparent substrate 12. Thus, the interfacial reflection and refraction of the light passing through the touch panel 10 can be lower than when an air layer is formed in the gap between the third transparent substrate 11 and the fourth transparent substrate 12. As a result, an image displayed on the display panel 1 can be observed with sufficient brightness.

That is, the refractive index of the third transparent substrate 11 and the fourth transparent substrate 12 is about 1.5, the refractive index of the insulating liquid 33 ranges from about 1.4 to 1.6, and the refractive index of ITO films serving as the first resistive film 13 and the second resistive film 14 is about 1.8. Thus, light which has entered the touch panel 10 in one direction, for example, from the side of the fourth transparent substrate 12 is refracted at the interface between the fourth transparent substrate 12 and the second resistive film 14 in a direction in which the angle with the normal direction of the touch panel 10 increases. Then, this light is refracted at the interface between the second resistive film 14 and the layer of the insulating liquid 33 in a direction in which the angle with the normal direction of the touch panel 10 decreases. Further, this light is refracted at the interface between the layer of the insulating liquid 33 and the first resistive film 13 in a direction in which the angle with the normal direction of the touch panel 10 increases. Finally, this light is refracted between the first resistive film 13 and the third transparent substrate 11 in a direction in which the angle with the normal direction of the touch panel 10 decreases.

Here, as the first resistive film 13 is an extremely thin film having a thickness of 0.05 to 0.20 μm, the difference between the entrance position of the light at the interface between the fourth transparent substrate 12 and the second resistive film 14 and the exit position of the light at the interface between the second resistive film 14 and the layer of the insulating liquid 33 is negligible.

Similarly, as the second resistive film 14 is an extremely thin film having a thickness of 0.05 to 0.20 μm, the difference between the entrance position of the light at the interface between the layer of the insulating liquid 33 and the first resistive film 13 and the exit position of the light at the interface between the first resistive film 13 and the third transparent substrate 11 is negligible.

Therefore, the difference between the positions at which the light enters or exits from the touch panel 10 substantially corresponds to the difference in refractive index between the third transparent substrate 11 or the fourth transparent substrate 12 and the insulating liquid 33. If the difference in refractive index is 0.1 or less, the refraction at the apparent interface between the third transparent substrate 11 or the fourth transparent substrate 12 and the layer of the insulating liquid 33 can be effectively reduced.

In addition, as the insulating liquid 33, an organic or inorganic insulating liquid substance of which boiling point is 100° C. or more can be used. Specifically, it is possible to use an organic liquid substance such as butanol, toluene, xylene, an isobutyl alcohol, an isopentyl alcohol, isobutyl acetate, butyl acetate, tetrachlorethylene, methyl isobutyl ketone, methyl butyl ketone, ethylene glycol monoether, ethylene glycol monoether acetate, ethylene glycol monobutyl ether, ethylene glycol monomethyl ether or turpentine oil. Alternatively, it is possible to use an inorganic liquid substance such as silicon oil.

In any case, a material which is optically isotropic at room temperature is desirably used for the insulating liquid 33. Here, if, for example, a material which shows a liquid crystal phase at a temperature lower than 5° C. and which shows an isotropic phase at a temperature of 5° C. or more is used, the same device as a device for injecting liquid crystal into the liquid crystal display panel can be used to fill the gap with the insulating liquid 33, and the layer of the insulating liquid 33 can be optically isotropic at room temperature, which is preferable.

The third transparent substrate 11 is not exclusively a glass plate, and may be a resin film. In this case, the refractive index varies between the third transparent substrate 11 and the fourth transparent substrate 12. However, if the difference in refractive index between at least one of the third transparent substrate 11 and the fourth transparent substrate 12 and the insulating liquid 33 is 0.1 or less, the refraction of light at the apparent interface can be relatively low.

Furthermore, in the touch panel 10, a plurality of contacts which are provided on the first resistive film 13 and which electrically contact the second resistive film 14 due to bending and deformation caused by touching from the side of the third transparent substrate 11 are formed as linear contacts along one direction. This enables higher load resistance than in the case of dot-shaped contacts in an independently projecting shape. That is, the touch panel 10 is sufficiently resistant to repetitive input touches or pounding-like strong input touches.

Moreover, as the linear contacts 15 are in a convex strip shape, the linear projections 16 configuring the linear contacts 15 can be formed using an exposure mask having simple striped patterns. Thus, the touch panel 10 in the embodiment is more advantageous in productivity than a touch panel in which the dot-shaped contacts are arranged with a predetermined pitch.

Still further, according to the touch panel 10 in the embodiment, the transparent first resistive film 13 is provided over the linear projections 16 to form the linear contacts 15, so that the linear projections 16 do not have to be formed of a conductive material. Thus, even when the linear projections 16 are to be transparent, a proper material can be selected from a great variety of materials.

Although the spacers 17 are formed on the side of the fourth transparent substrate 12 according to the touch panel 10 in the embodiment described above, the spacers 17 may be formed on the side of the third transparent substrate 11.

In the touch panel 10, when the third transparent substrate 11 is touched, the third transparent substrate 11 bends and deforms toward the fourth transparent substrate 12, and the linear contact 15 in the bent and deformed part contacts the second resistive film 14. At this contact position, the first resistive film 13 and the second resistive film 14 are brought into conduction. Thus, the touch panel drive circuit 36 shown in FIG. 11 alternately applies a voltage at a given value across both ends of the first resistive film 13 in the X-axis direction and across both ends of the second resistive film 14 in the Y-axis direction. Then, the voltage value at one end of the second resistive film 14 when the voltage is applied to the first resistive film 13 and the voltage value at one end of the first resistive film 13 when the voltage is applied to the second resistive film 14 are measured. On the basis of these voltage values, coordinates of the touched point in the X-axis direction and the Y-axis direction can be detected.

The touch panel drive circuit 36 includes a voltage applying circuit 37, a voltage measuring system 45 and coordinate detection circuit 50. The voltage applying circuit 37 alternately applies a voltage at a given value across both ends of the first resistive film 13 in the X-axis direction and across both ends of the second resistive film 14 in the Y-axis direction. The voltage measuring system 45 measures a voltage generated across a predetermined point on the voltage applying circuit 37 and one end of the first resistive film 13 in the X-axis direction or one end of the second resistive film 14 in the Y-axis direction when the first resistive film 13 and the second resistive film 14 are brought into conduction through the linear contacts 15 in the bent and deformed part of the third transparent substrate 11. The coordinate detection circuit 50 detects coordinates of the touched point on the basis of the measurement value obtained by the voltage measuring system 45.

The voltage applying circuit 37 includes a constant voltage power source 38, a first connection changing switch 41 and a second connection changing switch 44. The first connection changing switch 41 selectively supplies a voltage of one pole (negative pole in FIG. 11) of the constant voltage power source 38 to one end of the first resistive film 13 in the X-axis direction and one end of the second resistive film 14 in the Y-axis direction through first resistive film connecting wiring lines 39, 40 respectively connected to one end of the first resistive film 13 in the X-axis direction and one end of the second resistive film 14 in the Y-axis direction. The second connection changing switch 44 selectively supplies a voltage of the other pole (positive pole in FIG. 11) of the constant voltage power source 38 to the other end of the first resistive film 13 in the X-axis direction and the other end of the second resistive film 14 in the Y-axis direction through second resistive film connecting wiring lines 42, 43 respectively connected to the other end of the first resistive film 13 in the X-axis direction and the other end of the second resistive film 14 in the Y-axis direction.

Although the constant voltage power source 38 shown in FIG. 11 is a direct-current power source, the constant voltage power source 38 may be a power source for supplying an alternating voltage.

The voltage measuring system 45 includes a third connection changing switch 48 and a voltage detector 49. The third connection changing switch 48 selectively supplies, to the voltage detector 49, the voltage at one end of the first resistive film 13 in the X-axis direction and the voltage at one end of the second resistive film 14 in the Y-axis direction through third resistive film connecting wiring lines 46, 47 respectively connected to one end of the first resistive film 13 in the X-axis direction and one end of the second resistive film 14 in the Y-axis direction. The voltage detector 49 intervenes between one pole (negative pole in FIG. 11) of the constant voltage power source 38 and the third connection changing switch 48.

In accordance with unshown controller, the first and second connection changing switches 41, 44 are changed, with a predetermined period, for example, with a period of 0.1 seconds, between the side (state in FIG. 11) for connecting both ends of the first resistive film 13 in the X-axis direction to the constant voltage power source 38 and the side for connecting both ends of the second resistive film 14 in the Y-axis direction to the constant voltage power source 38. Thereby, the voltage applying circuit 37 alternately applies the voltage of the constant voltage power source 38 at a given value across both ends of the first resistive film 13 in the X-axis direction and across both ends of the second resistive film 14 in the Y-axis direction.

The coordinate detection circuit 50 is controlled by the unshown controller. The coordinate detection circuit 50 detects coordinates of the touched point in the X-axis direction (hereinafter referred to as X coordinates) on the basis of the measurement value obtained by the voltage detector 49 when the voltage is applied across both ends of the first resistive film 13 in the X-axis direction. The coordinate detection circuit 50 also detects coordinates of the touched point in the Y-axis direction (hereinafter referred to as Y coordinates) on the basis of the measurement value obtained by the voltage detector 49 when the voltage is applied across both ends of the second resistive film 14 in the Y-axis direction.

The X, Y coordinates of the touched point are detected on the basis of the measurement value obtained by the voltage detector 49 in accordance with the following computation.

A measurement voltage value V(x) obtained by the voltage detector 49 when a voltage V₀ is applied across both ends of the first resistive film 13 in the X-axis direction can be represented by,

as rₓ<<R,

V(x)=V₀(1−x)

wherein V₀ is the voltage value of the constant voltage power source 38, 0 is the value of the X coordinates at one end of the first resistive film 13 in the X-axis direction, 1 is the value of the X coordinates at the other end of the first resistive film 13 in the X-axis direction, x is the X coordinates of the touched point, rₓ is the value of resistance across both ends of the first resistive film 13 in the X-axis direction, and R is the value of the internal resistance of the voltage detector 49.

Moreover, a measurement voltage value V(y) obtained by the voltage detector 49 when the voltage V₀ is applied across both ends of the second resistive film 14 in the Y-axis direction can be represented by,

as r_{y}<<R,

V(y)=V₀(1−y)

wherein 0 is the value of the Y coordinates at one end of the second resistive film 14 in the Y-axis direction, 1 is the value of the Y coordinates at the other end of the second resistive film 14 in the Y-axis direction, y is the Y coordinates of the touched point, and rₓ is the value of resistance across both ends of the second resistive film 14 in the Y-axis direction.

Therefore, X coordinates x and Y coordinates y of the touched point can be found by

x=1−V(x)/V₀,

y=1−V(y)/V₀.

Furthermore, in the touch panel 10, the two first electrodes 23a, 23b in a continuous belt shape are provided to face each other over the substantially entire lengths of the side portions at both ends of the first resistive film 13 in the X-axis direction. The two second electrodes 24a, 24b in a continuous belt shape are provided over the substantially entire lengths of the side portions at both ends of the second resistive film 14 in the Y-axis direction. The first electrodes 23a, 23b and the second electrodes 24a, 24b are respectively connected to the drive circuit connecting terminals 25a, 25b, 26a, 26b provided in the extension 12a of the opposite substrate 12 by the wiring lines 27a, 27b, 28a, 28b. As a result, the voltage alternately applied by the touch panel drive circuit 36 across both ends of the first resistive film 13 in the X-axis direction and across both ends of the second resistive film 14 in the Y-axis direction equally acts on the substantially entire first resistive film 13 and second resistive film 14, so that the X coordinates x and Y coordinates y of the touched point can be accurately detected.

Consequently, the touch-panel-equipped display apparatus shown in FIG. 1 provides keyboard-like touch input, wherein a plurality of key patterns are displayed on the display panel 1, and parts corresponding to the key patterns in the touch panel 10 are selectively touched. In addition to this keyboard-like touch input, the touch-panel-equipped display apparatus provides the following functions. For example, an image is displayed on the display panel 1, and a given point on the touch panel 10 is touched, whereby an enlarged image centered on the touched point is displayed on the display panel 1. Moreover, the touched point can be moved in a given direction on the touch panel 10 to scroll the image displayed on the display panel 1.

In addition, the first electrodes 23a, 23b and the second electrodes 24a, 24b are respectively formed into the continuous belt shape in the embodiment described above. However, the first electrodes 23a, 23b and the second electrodes 24a, 24b may be intermittently provided with a predetermined pitch over the substantially entire lengths of the side portions at both ends of the first resistive film 13 in the X-axis direction and over the substantially entire lengths of the side portions at both ends of the second resistive film 14 in the Y-axis direction, respectively. In this case as well, the voltage alternately applied across both ends of the first resistive film 13 in the X-axis direction and across both ends of the second resistive film 14 in the Y-axis direction equally acts on the substantially entire first resistive film 13 and second resistive film 14, so that the X coordinates x and Y coordinates y of the touched point can be accurately detected.

When the first electrodes 23a, 23b and the second electrodes 24a, 24b are thus intermittently provided over the substantially entire lengths of the side portions at both ends of the first resistive film 13 in the X-axis direction and over the substantially entire lengths of the side portions at both ends of the second resistive film 14 in the Y-axis direction, respectively, the first electrodes facing each other are connected to the common side portion at one end of the first resistive film 13 in the X-axis direction, the first electrodes facing each other are connected to the common side portion at the other end of the first resistive film 13 in the X-axis direction, the second electrodes facing each other are connected to the common side portion at one end of the second resistive film 14 in the Y-axis direction, and the second electrodes facing each other are connected to the common side portion at the other end of the second resistive film 14 in the Y-axis direction. Then, these electrodes can be connected to the drive circuit connecting terminals 25a, 25b, 26a, 26b provided in the extension 12a through the wiring lines 27a, 27b, 28a, 28b.

Furthermore, in the embodiment described above, an edge at the other end of the first resistive film 13 in the X-axis direction is electrically connected to the first electrodes 23a, 23b provided to face the ends of the first resistive film 13 by the spherical conductive particles 30 dispersed in the seal member 29. However, the side portion at the other end of the first resistive film 13 in the X-axis direction may be electrically connected to the first electrodes 23a, 23b through a columnar conductive member which is provided on the side portion or the first electrodes 23a, 23b to correspond to the seal portion formed by the seal member 29.

### Embodiment 2

Next, a touch panel according to a second embodiment of this invention shown in FIG. 12 is described. It is to be noted that parts in this embodiment equivalent to the parts in the first embodiment described above are provided with the same reference numbers and the same parts are not described.

In a touch panel 10a according to this embodiment, instead of the spacers 17 in the first embodiment, transparent columnar protrusions 18 covered with a first resistive film 13 are provided on one of a third transparent substrate 11 and a fourth transparent substrate 12 where linear projections 16 are provided, for example, on the third transparent substrate 11. Moreover, a second resistive film 14 is partly removed at positions corresponding to the columnar protrusions 18. That is, in the touch panel 10a, spacers 17a are formed by the columnar protrusions 18 and the first resistive film 13 overlapping the columnar protrusions 18. Then, the second resistive film 14 is partly removed in advance at positions where the spacers 17a contact the fourth transparent substrate 12, thereby preventing the first resistive film 13 and the second resistive film 14 from being brought into conduction by the spacers 17a. In addition, the removed part of the second resistive film 14 is provided as a hole 19 greater in area than the tip of the spacer 17a, and the tip of the spacer 17a is in contact with the fourth transparent substrate 12 so as to be in the hole 19.

Moreover, in the touch panel 10a according to this embodiment, means for preventing the conduction of the spacers 17a and the second resistive film 14 is not exclusively the hole 19. For example, insulating films may be provided on the parts of the second resistive film 14 corresponding to the spacers 17a so that the spacers 17a may come into contact with the insulating films.

### Embodiment 3

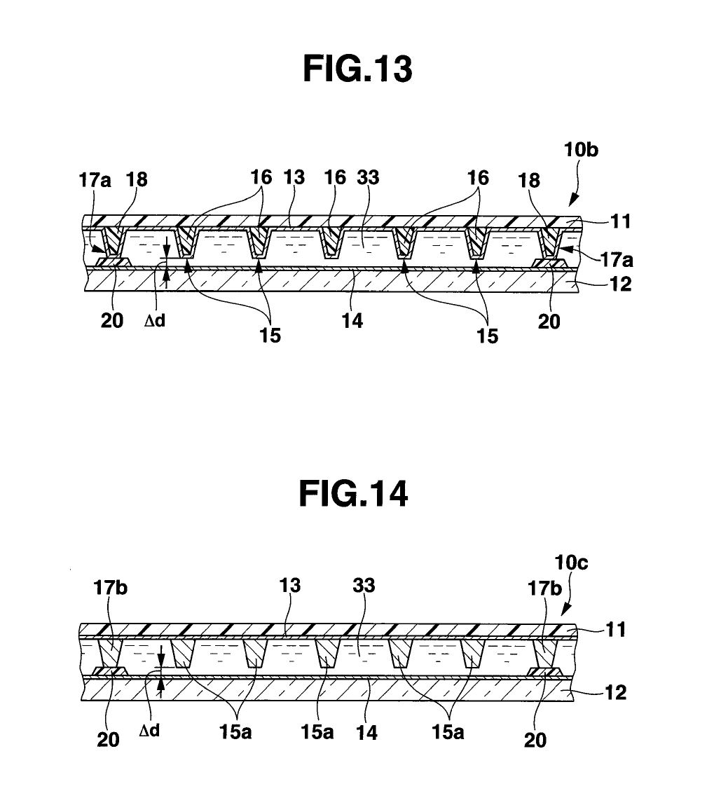

Next, a touch panel according to a third embodiment of this invention shown in FIG. 13 is described. It is to be noted that parts in this embodiment equivalent to the parts in the first and second embodiments described above are provided with the same reference numbers and the same parts are not described.

In a touch panel 10b according to this embodiment, a plurality of linear projections 16 for forming a plurality of linear contacts 15 and a plurality of protrusions 18 for forming a plurality of spacers 17a are formed at the same height on a third transparent substrate 11. A first resistive film 13 is provided over the linear projections 16 and the protrusions 18. That is, the linear projections 16 and the protrusions 18 are formed on the third transparent substrate 11 so that the linear contacts 15 and the spacers 17a are equal in height. Then, spacer receivers 20 made of an insulating material are provided with a predetermined thickness on parts of a second resistive film 14 corresponding to the spacers 17a. Thus, the tips of the spacers 17a are in contact with the spacer receivers 20.

The touch panel 10b according to this embodiment has such a configuration, so that the variation of a gap Δd between the linear contacts 15 and the second resistive film 14 per product (per touch panel) can be reduced.

That is, in the touch panel 10 according to the first embodiment described above, the spacers 17 are higher than the linear projections 16, and the gap Δd between the linear contacts 15 and the second resistive film 14 is regulated by the difference of height. Therefore, the gap Δd is subject to both the variation of the height of the linear projections 16 among products and the variation of the height of the spacers 17, 17a among products.

Thus, for example, in a product in which the linear projections 16 lower than a design value are formed and in which the spacers 17 higher than a design value are formed, the gap Δd is greater than a design value, so that the third transparent substrate 11 has to be greatly bent and deformed by strong touch force, which provides a sense of heavy touch.

Furthermore, in a product in which the linear projections 16 higher than the design value are formed and in which the spacers 17 lower than the design value are formed, the gap Δd is smaller than the design value, which provides a sense of extremely light touch. Thus, only a light touch on the third transparent substrate 11 may cause the linear contacts 15 to contact the second resistive film 14, resulting in erroneous input.

On the contrary, in the touch panel 10b according to the third embodiment, the linear contacts 15 and the spacers 17a are equal in height, and the gap Δd between the linear contacts 15 and the second resistive film 14 is set at the height corresponding to the thickness of the spacer receivers 20. Thus, the variation of the gap Δd only corresponds to the variation of the thickness of the spacer receivers 20.

Furthermore, the spacer receivers 20 have a thickness much smaller than the height of the linear contacts 15 and the spacers 17a. Therefore, the absolute value of the thickness of the spacer receivers 20 minimally varies. As a result, the gap Δd varies to a small extent among products, and a similar sense of touch can be obtained among products.

In addition, in the touch panel 10b according to the third embodiment described above, the spacer receivers 20 may be formed of SiO₂ or a photosensitive resin. An SiO₂ film can be formed with a precise thickness by a sputter device. Therefore, if the spacer receivers 20 are formed of SiO₂, there is hardly any error in the thickness of the spacer receivers 20, that is, there is hardly any error in the gap Δd in each product. As a result, the variation in the sense of touch among products can be more effectively reduced.

### Embodiment 4

Next, a touch panel according to a fourth embodiment of this invention shown in FIG. 14 is described. It is to be noted that parts in this embodiment equivalent to the parts in the first to third embodiments described above are provided with the same reference numbers and the same parts are not described.

In a touch panel 10c according to this embodiment, a first resistive film 13 is formed entirely flatly on a third transparent substrate 11, and a second resistive film 14 is formed entirely flatly on a fourth transparent substrate 12. Further, on the first resistive film 13, linear projections made of a conductive material are formed as linear contacts 15a, and dot-shaped projections made of a conductive material are formed as spacers 17b equally in height to the linear contacts 15a.

Furthermore, on the second resistive film 14, spacer receivers 20 made of an insulating material are provided with a predetermined thickness in parts corresponding to the spacers 17b.

In the touch panel 10c according to this embodiment, the linear contacts 15a and the spacers 17b can be formed by spin-coating the first resistive film 13 with a transparent resin to which power of a transparent conductive material such as ITO is added or with a transparent conductive material such as a conductive polymer (e.g., polyacetylene, polyparaphenylene, polyaniline, polythiophene or polyparaphenylenevinylene) to reach a thickness corresponding to the height of the linear contacts 15a and the spacers 17b, and then patterning this film.

### Embodiment 5

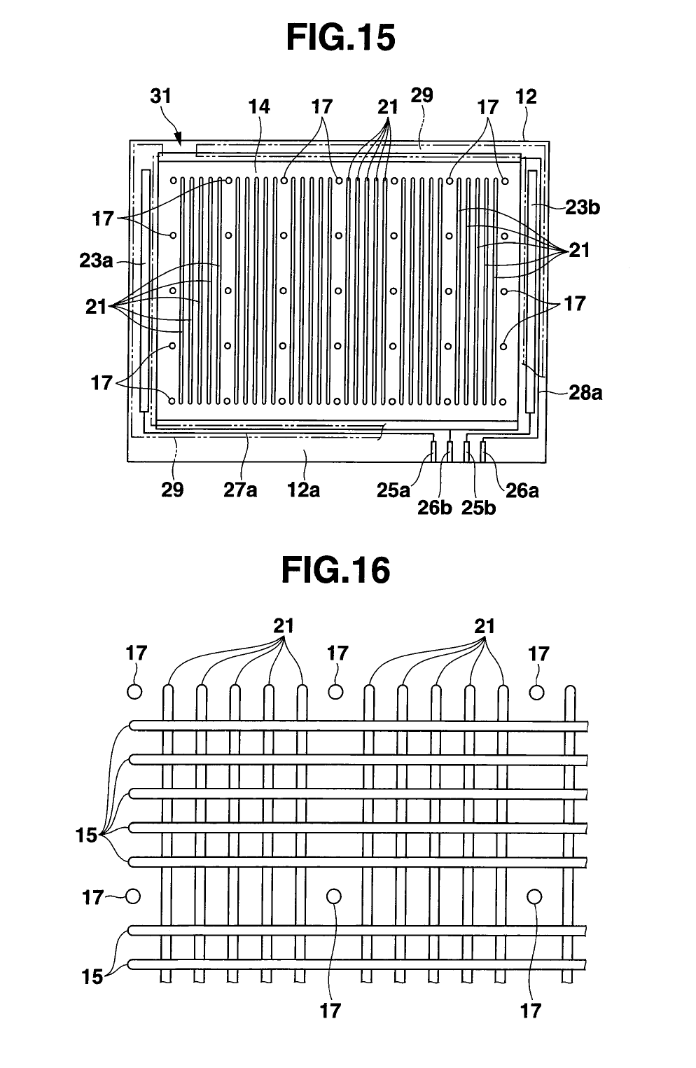

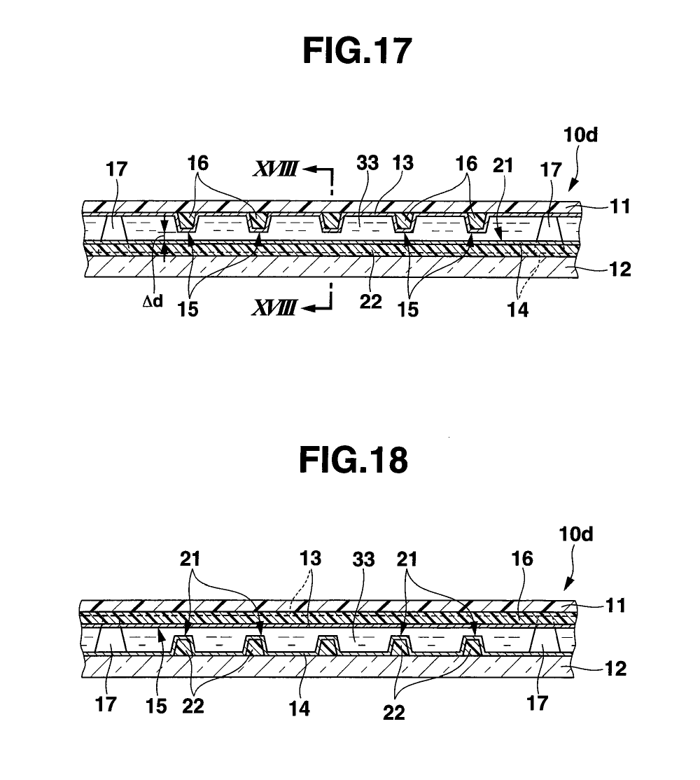

Next, a touch panel according to a fifth embodiment of this invention shown in FIG. 15 to FIG. 18 is described. It is to be noted that parts in this embodiment equivalent to the parts in the first to fourth embodiments described above are provided with the same reference numbers and the same parts are not described.

In a touch panel 10d according to this embodiment, a plurality of linear contacts 15 are provided on a third transparent substrate 11, and a plurality of linear contact receivers 21 extending in a direction intersecting with the extending direction of the linear contacts 15 are provided on a fourth transparent substrate 12. In addition, the linear contact receivers 21 are formed to have a height that allows the linear contact receivers 21 to contact the linear contacts 15 when the third transparent substrate 11 is touched and thereby bent and deformed.

The height of the linear contacts 15 and the height of the linear contact receivers 21 in this embodiment are about half the height of the linear contacts 15 in the first embodiment.

A plurality of linear projections 16 are provided on the third transparent substrate 11, and a first resistive film 13 is provided over the linear projections 16, so that the linear contacts 15 are formed by the parts of the first resistive film 13 covering the linear projections 16. A plurality of linear projections 22 are provided on the fourth transparent substrate 12, and a second resistive film 14 is provided over the linear projections 22, so that the linear contact receivers 21 are formed by the parts of the second resistive film 14 covering the linear projections 22.

Furthermore, in this embodiment, a plurality of spacers 17 are provided on one of the first resistive film 13 and the second resistive film 14, for example, on the second resistive film 14. The spacers 17 are made of a transparent insulating material, and have a height greater by a predetermined value than the sum of the height of the linear contact 15 and the height of the linear contact receiver 21. Then, the spacers 17 are brought into contact with the first resistive film 13, so that a gap Δd between the linear contacts 15 and parts of the second resistive film 14 in contact with the second resistive film 14 is set at a predetermined height.

That is, in the touch panel 10d according to this embodiment, the linear contact 15 is brought into contact with the linear contact receiver 21 by the bending and deformation of the third transparent substrate 11 caused by touching. At this contact position, the first resistive film 13 and the second resistive film 14 are brought into conduction.

In the touch panel 10d according to this embodiment, the linear contact receiver 21 are formed into a convex strip shape along a direction intersecting with the length direction of the linear contacts 15. The linear contact receiver 21 is preferably formed into a convex strip shape along a direction substantially perpendicular to the length direction of the linear contacts 15.

In the touch panel 10d according to this embodiment, the linear contact 15 is brought into contact with the linear contact receiver 21 by the bending and deformation of the third transparent substrate 11. Thus, the height of the linear contacts 15 and the height of the linear contact receivers 21 may be about half the height of the linear contacts 15 in the first embodiment.

Furthermore, the linear projections 16 for forming the linear contacts 15 and the linear projections 22 for forming the linear contact receivers 21 are respectively formed by spin-coating the third transparent substrate 11 and the fourth transparent substrate 12 with a photosensitive resin to reach a thickness corresponding to the height of the linear projections 16, 22 and developing the resin coating after exposed by use of an exposure mask having patterns corresponding to the planar shape and arrangement pitch of the linear projections 16, 22. In this case, the coating thickness of this photosensitive resin may be about half the coating thickness of the photosensitive resin for forming the linear projections 16 in the first embodiment. Therefore, a resin coating with a precise thickness can be formed. Moreover, as the thickness of the resin coating is small, the accuracy of the patterning of the resin coating by the exposure and development can be higher.

Moreover, in the touch panel 10d according to this embodiment, the linear contacts 15 and the linear contact receivers 21 are formed into a convex strip shape lower in height than the linear contacts 15 in the first embodiment described above. Thus, the load resistance of the linear contacts 15 and the linear contact receivers 21 can be higher than the load resistance of the linear contacts 15 in the first embodiment described above.

Still further, the linear contact receivers 21 are formed into a convex strip shape along a direction intersecting with (preferably, a direction substantially perpendicular to) the length direction of the linear contacts 15. This ensures that the linear contacts 15 are brought into contact with the linear contact receiver 21 by the bending and deformation of the third transparent substrate 11 even if there is an error in the accuracy of positioning between the third transparent substrate 11 and the fourth transparent substrate 12.

That is, the linear contact receivers 21 may be formed into a convex strip shape along a direction parallel to the length direction of the linear contacts 15. In that case, the linear contacts 15 and the linear contact receivers 21 may be out of place relative to each other due to an error in the accuracy of positioning between the third transparent substrate 11 and the fourth transparent substrate 12, so that the linear contacts 15 may not come into contact with the linear contact receivers 21.

On the contrary, as long as the length direction of the linear contacts 15 intersects with the length direction of the linear contact receivers 21, the linear contacts 15 always come into contact with the linear contact receivers 21 even if there is an error in the accuracy of positioning between the third transparent substrate 11 and the fourth transparent substrate 12.

Although the spacers 17 made of an insulating material are provided on either the first resistive film 13 or the second resistive film 14 (on the second resistive film 14 in the drawings) in the fifth embodiment, the spacers 17 may be formed in the same manner as in the second to fourth embodiments. Moreover, as in the fourth embodiment, the linear contacts 15 and the linear contact receiver 21 may be formed by providing conductive linear projections on the first resistive film 13 or the second resistive film 14.

### Embodiment 6

Although the linear contacts 15, 15a are provided on the third transparent substrate 11 in the embodiments described above, the linear contacts 15, 15a may be provided on the fourth transparent substrate 12.

Moreover, the gap between the third transparent substrate 11 and the fourth transparent substrate 12 is regulated by the columnar spacers 17, 17a, 17b in the embodiments described above, but the gap may be regulated by a plurality of spherical spacers.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A touch panel comprising:
a first substrate;
a second substrate disposed to face the first substrate;
an insulating liquid confined in a gap between the first substrate and the second substrate;
linear contacts formed on the first substrate in a region where the insulating liquid is confined, the linear contacts projecting at a predetermined height and extending in a predetermined direction; and
a resistive film formed on the second substrate so as to correspond to at least the location of the linear contacts.

2. The touch panel according to claim 1, further comprising spacers which maintain a constant gap between the first substrate and the second substrate, at least one linear contact being formed between two spacers adjacent in a direction perpendicular to the extending direction of the linear contacts.

3. The touch panel according to claim 1, wherein the linear contact extends in a direction along the long-side direction of the touch panel.

4. The touch panel according to claim 1, wherein the resistive film is made of ITO.

5. The touch panel according to claim 1, further comprising spacers which are formed on the first substrate so as to project higher than the linear contact and which maintain a constant gap between the first substrate and the second substrate, the resistive film being partly removed at positions corresponding to the spacers to form holes therein, the tips of the spacers being in contact with the second substrate through the holes.

6. The touch panel according to claim 5, wherein each of the spacers and the linear contacts includes a resin portion formed into a projection shape on the first substrate, and a resistive film formed on the first substrate so as to cover the resin portion.

7. The touch panel according to claim 6, further comprising a detection circuit which detects a coordinate position at which the resistive film formed on the first substrate and the resistive film formed on the second substrate are brought into electric conduction.

8. The touch panel according to claim 1, further comprising spacers which are formed on the first substrate so as to project at a height equal to the height of the linear contacts and which maintain a constant gap between the first substrate and the second substrate, and spacer receivers which are formed of an insulating material on the resistive film so as to expose regions corresponding to the linear contacts and so that the tips of the spacers are in contact with the spacer receivers.

9. The touch panel according to claim 8, wherein each of the spacers and the linear contacts includes a resin portion formed into a projection shape on the first substrate, and a resistive film formed on the first substrate so as to cover the resin portion.

10. The touch panel according to claim 9, further comprising a detection circuit which detects a coordinate position at which the resistive film formed on the first substrate and the resistive film formed on the second substrate are brought into electric conduction.

11. The touch panel according to claim 8, further comprising a resistive film formed on the first substrate, wherein each of the spacers and the linear contacts is formed, on the resistive film formed on the first substrate, as a projection made of a conductive material.

12. The touch panel according to claim 11, further comprising a detection circuit which detects a coordinate position at which the resistive film formed on the first substrate and the resistive film formed on the second substrate are brought into electric conduction through the projections.

13. The touch panel according to claim 1, wherein the first substrate and the second substrate are joined together by a frame-like seal member, and the insulating liquid is confined in a region enclosed by the seal member.

14. The touch panel according to claim 1, wherein the insulating liquid transits to liquid crystal at less than 5° C.

15. The touch panel according to claim 1, wherein the first substrate and the second substrate are joined together by a frame-like seal member, and the linear contacts are formed in a region enclosed by the seal member.

16. A touch panel comprising:
a first substrate;
a second substrate disposed to face the first substrate;
an insulating liquid confined in a gap between the first substrate and the second substrate;
linear contacts formed on the first substrate in a region where the insulating liquid is confined, the linear contacts projecting at a predetermined height and extending in a predetermined direction; and
linear contact receivers formed on the second substrate, the linear contact receivers projecting at a predetermined height and extending in a direction intersecting with the extending direction of the linear contacts.

17. The touch panel according to claim 16, further comprising spacers which are formed at a height greater than the addition of the height of the linear contacts to the height of the linear contact receivers and which maintain a constant gap between the first substrate and the second substrate.

18. The touch panel according to claim 17, wherein each of the linear contacts includes a first resin portion formed into a projection shape on the first substrate, and a first resistive film formed on the first substrate so as to cover the first resin portion, and each of the linear contact receiver includes a second resin portion formed into a projection shape on the second substrate, and a second resistive film formed on the second substrate so as to cover the second resin portion.

19. The touch panel according to claim 18, further comprising a detection circuit which detects a coordinate position at which the first resistive film and the second resistive film are brought into electric conduction.

20. The touch panel according to claim 19, wherein the first resistive film and the second resistive film are made of ITO.
